(19) United States
(12) Patent Application Publication
(10) Pub. No.: US 2024/0384424 A1
(43) Pub. Date: Nov. 21, 2024

(54) Construction of an electrochemical cell

(71) Applicant: Evonik Operations GmbH, Essen (DE)

(72) Inventors: Artjom MALJUSCH, Bochum (DE); Patrick BOROWSKI, Bottrop (DE); Ines ELKEMANN, Coesfeld (DE); Philipp ROTERS, Coesfeld (DE)

(73) Assignee: Evonik Operations GmbH, Essen (DE)

(21) Appl. No.: 18/664,593

(22) Filed: May 15, 2024

(30) Foreign Application Priority Data
May 15, 2023 (EP) 23173271.0

(51) Int. Cl. C25B 11/061; C25B 1/04; C25B 9/19; C25B 9/77; C25B 11/031; C25B 11/085

(52) U.S. Cl. CPC C25B 11/061; C25B 1/04; C25B 9/19; C25B 9/77; C25B 11/031; C25B 11/085

(57) ABSTRACT

An electrochemical cell (0) including an anode (1), a cathode (2) and an anion-conducting membrane (3) arranged between anode (1) and cathode (2). It also relates to the use of the electrochemical cell (0) in a process for producing hydrogen (H₂) and oxygen (O₂) by electrochemical splitting of water (H₂O). The invention additionally relates to an electrolyser (6) having a multitude of cells (0) and to a process for producing the electrolyser (6). With the electrochemical cell (0) an AEM water electrolysis can be carried out on an industrial scale.

The present invention relates to an electrochemical cell comprising an anode, a cathode and an anion-conducting membrane arranged between anode and cathode. It also relates to the use of the electrochemical cell in a process for producing hydrogen and oxygen by electrochemical splitting of water. The invention additionally relates to an electrolyser having a multitude of cells and to a process for producing the electrolyser.

Electrochemical cells are used for the performance of electrochemical processes. There is a multitude of electrochemical processes having very different objectives. An important electrochemical process is the breakdown of chemical compounds. This process is called electrolysis.

The industrial implementation of an electrochemical cell for the performance of electrolyses is called an electrolyser. An electrolyser usually comprises a multitude of interconnected electrochemical cells.

An electrochemical cell has at least two electrodes: an anode and a cathode. The cell is usually divided into two compartments by an electrically insulating separator. The anode is present in the first, “anodic” compartment, and the cathode in the second, “cathodic” compartment. The two electrodes or compartments are electrically separated from one another by the separator. The electrochemical cell is filled with electrolyte.

An important electrochemical process is the production of hydrogen and oxygen by electrochemical splitting of water. One variant of water electrolysis is characterized by the use of an anion-conducting membrane (anion-exchange membrane, AEM) as separator. It is commonly referred to as AEM water electrolysis (AEMWE). Since the reaction takes place in an alkaline medium, AEM water electrolysis is often also called alkaline membrane water electrolysis.

In AEM water electrolysis, an electrochemical cell is filled with water or with a basic water-based electrolyte, and a voltage is applied between anode and cathode. On the cathode side, the water (H₂O) is broken down into hydrogen (H₂) and hydroxide ions (OH⁻) (equation K). The anion exchange membrane transports the hydroxide ions onto the anode side, where they are oxidized to oxygen (O₂) (equation A). This results in evolution of oxygen on the anode side, alongside evolution of hydrogen on the cathode side. Consequently, the anode side is also called oxygen side, while the cathode side is also called hydrogen side.

2H₂O+2e⁻→H₂+2OH⁻ (C) reduction/cathode reaction

2OH→½O₂+H₂O+2e⁻ (A) oxidation/anode reaction

In order to permit the effect described, the membrane must conduct the hydroxide ions between anode and cathode. At the same time, it must be electrically insulating in order that there is no electrical short circuit between anode and cathode. Finally, the anion-conducting membrane must if possible be gas-tight, in order that there is no backmixing of the gases evolved. Moreover, the anion-conducting membrane must withstand the alkaline conditions that exist in AEM water electrolysis. These properties are fulfilled by special anion-conducting polymers (also called anion-conducting ionomers).

In order to accelerate the reaction, catalytically active substances (also called electrocatalysts) are incorporated both on the cathode side and on the anode side. This is accomplished by introducing catalytically active layers. These may be present on a substrate material specially introduced into the cell for the purpose or on a porous transport layer (catalyst-coated substrate, CCS), or else the membrane may be directly coated with catalytically active material (catalyst-coated membrane, CCM).

In AEM water electrolysis, a flow of water or electrolyte through the cell and a flow of gas out of the cell must be achieved in order to supply fresh water for the electrolysis and in turn to discharge hydrogen and oxygen, or water or electrolyte enriched therewith. This is generally enabled by a porous transport layer (PTL) that firstly closely adjoins the catalytically active layer in order to enable good electrical contact; it is secondly electrically conductive and has sufficient porosity for outward transport of gas and for supply of water and electrolyte. In order to improve the transport of water or electrolyte through the cell, a specific channel structure (known as the flow field) is incorporated into the cell. This structure is to have electrical contact with the porous transport layer, is to be electrically conductive and is to establish electrical contact with a bipolar plate (BPP). The bipolar plates electrically connect two adjacent cells. A specific channel structure is often incorporated directly into the bipolar plate, for example by mechanical deformation. For efficient water electrolysis, it is particularly important that the contact resistances at the contact surfaces (i) of catalytically active layer with the porous transport layer, (ii) of porous transport layer with the flow field, and (iii) of the flow field with bipolar plate are kept as low as possible and do not rise during the operation of the electrolyser as a result of oxidation of the contact surfaces. Otherwise, the elevated contact resistances will lead to higher cell voltage and lower efficiency, and to higher energy consumption.

An excellent overview of the construction and materials of the electrochemical cells currently in use in AEM water electrolysis is given by:
Miller, Hamish Andrew et al: Green hydrogen from anion exchange membrane water electrolysis: a review of recent developments in critical materials and operating conditions. Sustainable Energy Fuels, 2020, 4, 2114 DOI: 10.1039/c9se01240k

The general aims of the development of electrolysers for water electrolysis are the improvement of the efficiency of the process and the reduction of manufacturing costs for the electrolyser.

In the cited review by Miller et al, nickel foams are mentioned as electrode material. Foams are porous structures.

EP 3453785 A1 describes an electrochemical cell for basic water electrolysis. It discloses in paragraph [0022] an anode having a feeder layer (17) that is partly made of a metal nonwoven or metal foam. The material specified in paragraph [0023] is nickel or stainless steel. Arranged between the nonwoven and the membrane (13) is another catalyst layer (15); see FIG. 1 and paragraphs [0015] and [0027]. The electrode-catalyst layer-membrane-catalyst layer-electrode sandwich structure (see paragraph [0053]) of the electrochemical cell is very space-consuming. This is particularly disadvantageous when many such cells are to be connected in an electrolyser. In this case, not only the space occupied by the electrolyser but also the internal resistance of the cell stack increases. This reduces the energy efficiency of the process. A good feature of the electrochemical cell shown in EP 3453785 A1 is the fluid management: To improve the flow of water into the compartments and the gas outflow from the compartments, the membrane is provided with channels; paragraph [0054]. This electrochemical cell therefore appears to be suitable in principle for industrial water electrolysis. The disadvantage is the space-consuming layer structure and the high production costs that arise from incorporation of the catalyst layers: These contain valuable metals that serve as electrocatalysts; see paragraph [0029].

WO 2020260370 A1 describes an electrochemical cell in which one compartment can be operated dry. On page 5 a CCS on a nickel nonwoven or foam is mentioned. A CCS does however always have a catalyst layer. Metal oxides, for example copper-cobalt oxide, are recommended as electrocatalyst for the anode on page 6 above. However, WO 2020260370 A1 on page 6 advises against Pt catalysts for reasons of cost.

WO 2016142382 A1 discloses in FIG. 2 an embodiment I of a (photo) electrochemical cell having a cathode (corrosion protection layer 15 of the photoelectrode 2), an anion-conducting membrane (2) and an anode (counterelectrode 3). Arranged between the anode (3) and membrane (2) is a porous nickel-containing structure (5A). The porous nickel-containing structure (5A) can consist of nickel fibres or stainless steel fibres. Nickel foam is also conceivable (page 12). As shown in FIG. 2 and described on page 17, the anode (counterelectrode 3) is spaced apart from the membrane. The porous nickel-containing structure (5A) is arranged therebetween. The disadvantage of this cell is its voluminous layer structure.

A more slimline solution is embodiment II of WO 2016142382 A1, which does not require a porous nickel-containing structure. The porosity required for the fluid conduction is realized in the membrane. Since the photoelectrochemical cell has an integrated voltage source (namely the photoelectrode), the electrical energy available for the water electrolysis is limited. When purely light-driven, the electrolysis capacity is low. In industrial water electrolysis with external electrical energy, large amounts of gaseous hydrogen and oxygen are evolved, which must be conducted out of the cell. The porous structure integrated in the membrane in embodiment II is not designed for this amount of gas. The build in embodiment II is nevertheless too large for a compact design of an electrolyser on an industrial scale.

EP4181240 A1, which had not yet been published at the time of filing, also concerns an electrochemical cell for use in water electrolysis that has a textile electrode comprising nickel. The textile electrode directly adjoins the membrane.

With regard to this prior art, it is an object of the present invention to specify an electrochemical cell with which an AEM water electrolysis can be carried out on an industrial scale. The cell should give rise to low production costs, build in a space-saving manner and permit energy-efficient production of hydrogen and oxygen in large amounts.

This object is achieved by an electrochemical cell according to claim 1.

The invention accordingly provides an electrochemical cell intended for alkaline membrane water electrolysis, comprising an anode, a cathode and an anion-conducting membrane arranged between anode and cathode, in which the anode is partly or entirely executed as a first porous sintered body comprising grains that are fused together at their grain boundaries, and in which the first porous sintered body is in direct contact with the membrane.

An essential finding of the present invention is that porous structures in the form of sintered bodies are not only suitable as an electrode, but can at the same time also assume the function of a porous transport layer for the electrolyte and/or the evolved gases: sintered bodies are fundamentally porous, since there are cavities between the individual grains. This is because the grains are irregularly shaped and sometimes only fused together in places. The water or electrolyte can penetrate into these cavities and thereby come into contact with the electrode material. This makes it possible for the reactants to reach the catalytically active centres directly, through the porous cavities in the sintered body. The gas evolved can likewise escape through the cavities. The sintered body accordingly fulfils not just electrochemical functions, but fluidic functions too. Their fluid-conducting properties enable the porous electrodes to be in direct contact with the membrane. This means that the sintered body directly adjoins the membrane in a planar manner. There is therefore no catalyst layer arranged between the anode and the membrane. Thus there is direct mechanical contact between the membrane and the sintered body, preferably over the entire interface between membrane and electrode. However, there can be no question of contact in an electrical sense because the membrane is not electrically conductive. By virtue of the fluid-conducting properties of the sintered body, the electrochemical cell of the invention can work without an additional porous transport layer. This reduces the electrical internal resistance of the cell, since there are no contact resistances between the individual components typically used. It may nevertheless be necessary to incorporate into the electrochemical cell flow fields that conduct electrolyte and gases into and out of the cell. The flow fields are however positioned facing away from the membrane; preferably, flow fields are incorporated in bipolar plates or end plates. Flow fields have a much larger flow cross section by comparison with the pores of the sintered body.

A sintered body differs from known textile structures in that it is not constructed from linear textile structures, i.e. fibres, yarns, threads or wires. A sintered body is instead formed from grains.

A sintered body differs from known metal foams in that it is formed from grains that are at least in places connected at the grain boundaries. The sintered body is therefore not monolithic. On the other hand, a metal foam has a monolithic metallic disperse phase in which a gas phase is dispersed. The pores of sintered bodies are typically much smaller than the individual grains. Metal foams by contrast have comparatively large pores relative to their metallic phase.

In a particularly preferred embodiment, the grains of the sintered body consist of a catalytically active material or at least comprise it. “Catalytically active” in this context means that the material is able to accelerate an electrochemical reaction that is being carried out in the electrochemical cell. The catalytically active material is thus an electrocatalyst.

The use of catalytically active sintered material permits particularly intimate contact of the reactants with the catalytically active centres present in the grains of the sintered material. The electrochemical reaction can thus be carried out very close to the membrane, which means that the ions that form are able to pass directly through the membrane into the opposite compartment.

Materials that are electrocatalytically active generally contain transition metals. Transition elements are for the purposes of the invention: Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg, Ac, Rf, Db, Sg, Bh, Hs, Mt, Ds, Rg. Sintered materials comprising a transition element have a higher electrocatalytic activity than sintered materials with no transition element. Moreover, the comparatively good electrical conductivity of the transition metals lowers the internal electrical resistance of the electrochemical cell.

Very particularly preferably, nickel is used as electrocatalytically active material. Accordingly, in a preferred embodiment of the invention the grains of the sintered body comprise nickel or consist of nickel. The grains are then themselves electrocatalytically active.

Nickel is a comparatively inexpensive transition metal with good catalytic properties, especially in water electrolysis. Furthermore, there are some nickel-containing materials that can be readily sintered into an anode. These materials include pure nickel, nickel-containing alloys such as in particular Hastelloy, Chronin, Monel, Inconel, Incoloy, Invar, Kovar; steel containing nickel, stainless steel containing nickel, and steel of the AISI 301, AISI 301L, AISI 304, AISI 304L, AISI 310, AISI310L, AISI316, AISI 316L, AISI 317, AISI 317L and AISI 321 steel types.

Accordingly, in a particularly preferred embodiment of the invention the anode is at least partly executed as a first sintered body, the grains of which consist of a nickel-containing material.

An additional advantage of the electrochemical cell of the invention is that there is no absolute need for an ionomer (also often referred to as binder) for immobilization of electrocatalysts on the substrate or electrode (CCS) or directly on the membrane (CCM). Oxygen formed during the electrolysis is very active and can chemically attack (oxidize) the ionomer, which leads to impairment of the mechanical properties of the ionomer and can also cause detachment of the electrocatalyst. This then leads to an increase in the cell voltage required and to elevated energy consumption. When the sintered body itself is electrocatalytically active, there is however less risk of catalyst detachment. As a result, the proposed structure of an electrochemical cell reduces the manufacturing costs thereof and, on account of the low electrical resistances, permits an energy-efficient process.

Given the advantages of the sintered structure, the anode is preferably executed entirely in the form of a porous sintered body. However, it is also conceivable to use an anode that is executed only partly in the form of a porous sintered body and otherwise consists of non-sintered material. Non-sintered here means without recognizable grain boundaries. Thus, the sintered body could also be mounted on a solid plate or on a flat or shaped metal sheet or on a different porous structure such as a metal foam, expanded metal or expanded metal mesh.

Preferably, the first sintered body is free of a catalytically active coating that differs from the material of the sintered body. The catalysis of the anode reaction is in that case effected exclusively by the electrocatalytically active material present in the sintered body or of which the grains of the sintered body consist.

The porosity P of the first porous sintered body used as anode should be between 5% and 60% or between 15% and 45%. The porosity P is here determined according to the following formula:

$$P = 1 - {ρ}_{V} / {ρ}_{M} .$$

In this formula, ρ_{V} is the volumetric density of the porous sintered body and ρ_{M} the solid density of the grains. ρ_{V} describes the macroscopic density of the entire sintered body, while ρ_{M} describes the microscopic density of the sintered material of which the grains consist.

By comparison with a foam, a sintered body has a considerably lower porosity: the porosity of nickel foams typically varies between 80% and 90%; cf. Table 1 in
Rocha Fernando et al.: Effect of pore size and electrolyte flow rate on the bubble removal efficiency of 3D pure Ni foam electrodes during alkaline water electrolysis. Journal of Environmental Chemical Engineering, vol. 10, No. 3, 1 Apr. 2022 (2022-04-01), page 107648 ISSN: 2213-3437, DOI: 10.1016/3.jece.2022.107648

In the simplest case, the porosity within the first sintered body is the same everywhere. Preferably, the porosity within the first sintered body can change, specifically along a (imaginary) gradient disposed perpendicularly to an interface between the first porous sintered body and membrane. The porosity P should decrease in the direction of the membrane such that the first sintered body has lower porosity at the interface with the membrane than at the side of the anode remote from the membrane. This means that the catalytically active centres are concentrated at the membrane, with the result that the electrochemical reaction is particularly intense there. This shortens the paths of the ions generated at the anode.

Preferably, the pores of the first porous sintered body are smaller than the grains of the first porous sintered body. This is a major difference relative to foams in which the pores are larger than the solid material. The size differences can be easily estimated by light microscopy, namely by examining a section through the first porous sintered body. The pore size of the sintered body shows a random distribution. The pore size is typically between 1 μm and 200 μm. The pore size of the sintered body is also much smaller than typical flow cross sections of flow fields in the 1 mm range.

The grain size of the sintered bodies likewise shows a random distribution. Evaluating differences in pore size and grain size is not a matter of comparing the extreme values but rather of comparing the median values: it is not harmful if individual, extremely large pores are larger than extremely small grains, provided the median pore size is smaller than the median grain size. The property of the sintered bodies that their pore size is smaller than their grain size means statistically that the median pore size is smaller than the median grain size.

The first porous sintered body may also be formed from at least two layers, where the two layers have different porosity or consist of grains of different particle size. The layer with lower porosity or composed of finer particles must then be arranged closer to the membrane than the layer with higher porosity or composed of coarser particles. The effect of this is that the porosity of the electrode decreases towards the membrane, in other words the electrode becomes denser and consists of finer grains. This is advisable because a greater density of the catalytically active sites is needed close to the membrane, whereas greater permeability for water or electrolyte and gases formed is required away from the membrane. It is also possible to form the sintered body from more than two layers, for example from three or four or five or six layers. The porosity of the individual layers or the particle size of the sintered grains then decreases stepwise from layer to layer in the direction of the membrane. This results in the realization of the gradient already mentioned above. The sintered layers may be joined to one another via the grain boundaries, with the result that the sintered body can be handled as a single component despite the layer structure. This facilitates the assembly of the cell.

Since the nickel-containing sintered bodies described herein are also suitable as cathodes, it is conceivable for not just the anode, but also the cathode to be produced from a sintered, catalytically active material. Therefore, in a preferred development of the electrochemical cell, the cathode thereof is partly or entirely executed as a second porous sintered body comprising grains that are fused together at their grain boundaries.

In order to distinguish between sintered bodies utilized as cathode and as anode, the term “first porous sintered body” is used here for the anode, while the term “second porous sintered body” is used for the cathode.

On the cathode side, integration of the catalytic activity into the sintered material is not absolutely necessary. Nevertheless, it is preferable when catalytically active material is used for the second sintered body too. The same material as on the anode side is suitable here. In the simplest case, the same material is utilized both on the anode side and on the cathode side. However, this need not necessarily be the case. Therefore, a distinction between first and second sintered body is appropriate. Preferably, the cathode is executed entirely as a porous sintered body.

The second porous sintered body, as well as the electrochemical function as a cathode, fulfils the function of a porous transport layer.

An electrochemical cell may on the cathode side be structured in two variants:

In a first variant, the cathode (hydrogen side, executed in particular as a second porous sintered body) is in direct contact with the membrane. Where the membrane in that case is itself not coated with any catalytically active material (electrocatalyst), this requires that the catalytically active substances have been applied to the cathode or that the cathode material itself is catalytically active. In a second variant, a catalytically active layer (electrocatalyst) is arranged between the cathode (hydrogen side, executed in particular as a second porous sintered body) and the membrane. The grains from which the second sintered body is formed need then not necessarily be catalytically active or coated with catalytically active substances. The grains of the second sintered body in this case must merely be electrically conductive in order to permit electrical contact between catalytically active layer (electrocatalyst) and flow field or bipolar plate. This structure is advantageous when an electrocatalyst is to be used that cannot be integrated into the grains or from which it is not possible for grains to be produced, or that cannot be applied to the second porous sintered body in a manner having enduring stability, or that has higher catalytic activity than the sintered material itself or than the catalytically active substances formed on the surface of the grains during operation of the electrolyser.

As already mentioned above, the variant of the invention with the catalyst layer between cathode and membrane has the advantage that it can contain electrocatalysts that cannot be applied readily to the second sintered body. Thus, the catalyst layer may contain catalytically active particles (electrocatalysts) comprising elements such as Pt, Ru, Pd, C, Ni, Mn, Mo, Co, Cu, Fe, Cr.

It is particularly advantageous when the catalytically active particles of the electrocatalyst are embedded in an anion-conducting polymer. The catalyst layer is in that case composed at least of the catalytically active particles and the anion-conducting polymer. Ion-conducting polymers are called ionomers. The embedding of the catalytically active particles into the anion-conducting ionomer enables makes it possible for hydroxide ions formed during the reduction of water at the cathode to be conducted into the membrane immediately after the reaction. It is very particularly preferable when the anion-conducting polymer has very good adhesion to the surface of the membrane and conducts hydroxide ions very well. In that case, there is particularly effective integration of the catalyst particles with the membrane and particularly good ionic bonding of the catalyst particles to the membrane.

However, in contrast to the known CCM design (membrane coated with electrocatalysts on both sides), the membrane of the structure of the invention is provided with a catalyst layer on at most the cathodic, hydrogen-producing side. It does not have any catalyst layer on the anodic, oxygen-producing side; the electrocatalyst is on the oxygen side integrated into the sintered anode material. Consequently, the variant with a catalyst layer exclusively on the cathode side may be regarded as a “semi-CCM cell”.

The separation-active material from which the anion-conducting membrane is formed is also an anion-conducting ionomer. In principle, all anion-conducting ionomers can be incorporated into the electrochemical cell of the invention and there assume the function of separation-active membrane material and/or be used for immobilization of catalytically active particles.

In a preferred embodiment of the invention, the membrane comprises the same anion-conducting polymer as the catalytically active coating that immobilizes the catalyst on the hydrogen side. The ionomer in the catalyst layer and the ionomer in the membrane should at least have the same repeat unit in the anion-conducting polymer; the chain length may be different.

Particular preference is given to using an anion-conducting polymer that obeys the structural formula (I) or (II) or (III).

The common advantage of the ionomers of the structural formula (I), (II) or (III) is their good ionic conductivity, high swelling resistance in an alkaline medium, and low synthesis costs.

The ionomers of the structural formula (I) or (II) or (III) may be used either for production of the membrane or as binder for immobilization of electrocatalysts in the catalytically active layer or on inactive sintered material.

The anion-conducting polymer of the structural formula (I) is defined as follows:

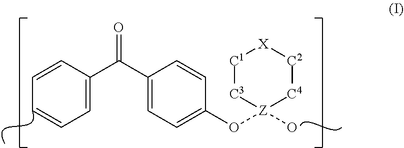

in which X is a structural element containing a positively charged nitrogen atom that is attached to C¹ and C² and that is attached via two bonds to one or two hydrocarbon radicals containing 1 to 12, preferably 1 to 6, more preferably 1 or 5, carbon atoms, and in which Z is a structural element containing a carbon atom that is attached to C³ and C⁴ and that contains at least one aromatic six-membered ring attached directly to one of the oxygen atoms, where the aromatic six-membered rings may be substituted by one or more halogen radicals and/or one or more C₁ to C₄ alkyl radicals.

The preparation of ionomers of the structural formula (I) is described in WO 2021/013694 A1.

The anion-conducting polymer of the structural formula (II) is defined as follows:

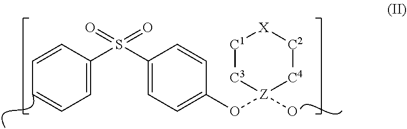

in which X is a structural element containing a positively charged nitrogen atom that is attached to C¹ and C² and that is attached via two bonds to one or two hydrocarbon radicals containing 1 to 12, preferably 1 to 6, more preferably 1 or 5, carbon atoms, and in which Z is a structural element containing a carbon atom that is attached to C³ and C⁴ and that contains at least one aromatic six-membered ring attached directly to one of the oxygen atoms, where the aromatic six-membered ring may be substituted in the 3 and 5 positions with identical or different C₁ to C₄ alkyl radicals, in particular with a methyl, isopropyl or tert-butyl group, preference being given to a methyl group.

The preparation of ionomers of the structural formula (II) is described in EP4032934A1.

The anion-conducting polymer of the structural formula (III) is defined as follows:

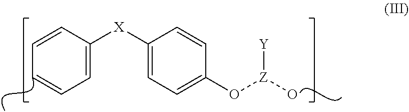

in which X is a ketone or sulfone group;
in which Z is a structural element containing at least one tertiary carbon atom and at least one aromatic six-membered ring, where the aromatic six-membered ring is directly attached to one of the two oxygen atoms;
in which Y is a structural element containing at least one nitrogen atom having a positive charge, where this nitrogen atom is attached to the structural element Z.

The preparation of ionomers of the structural formula (III) is described in EP4059988A1.

Irrespective of whether the electrochemical cell is furnished with one or two porous sintered bodies (electrodes), it is advantageous when the first sintered body and/or the second sintered body is in contact with a bipolar plate on their side remote from the membrane. “In contact” here means not just in a mechanical sense, but in an electrical sense too, because a bipolar plate is electrically conductive. Contacting preferably takes place over the entire area. More preferably, direct contacting is envisaged, in which no further material is incorporated into the cell between electrode and bipolar plate. This makes the cell particularly compact and cost-efficient. Optimal use is then made of the fluid-conducting functions of the porous sintered body. The bipolar plate can be used to create electrical contact with an adjacent electrochemical cell. This makes it possible to save space by stacking multiple electrochemical cells connected in series; see below.

The bipolar plate preferably consists of one of the following materials: nickel; nickel-containing alloys, such as Hastelloy, Chronin, Monel, Inconel, Incoloy, Invar, Kovar; steel containing nickel, stainless steel containing nickel, steels of the AISI 301, AISI 301L, AISI 304, AISI 304L, AISI 310, AISI310L, AISI316, AISI 316L, AISI 317, AISI 317L and AISI 321 types; nickel-plated steel, nickel-plated stainless steel, nickel-plated titanium, nickel-plated brass, nickel-plated aluminium, nickel-plated acrylonitrile-butadiene-styrene copolymer, and carbon.

The electrochemical cell presented here is optimized for use in an alkaline water electrolysis (AEM water electrolysis). The invention therefore provides for the production of hydrogen and oxygen through an electrochemical splitting of water having the following process steps:
a) providing at least one electrochemical cell comprising an anode, a cathode and an anion-conducting membrane arranged between anode and cathode, in which the anode is at least partly executed as a first porous sintered body comprising grains that are fused together at their grain boundaries, and in which the first porous sintered body is in direct contact with the membrane;
b) providing an aqueous electrolyte having a pH of 7 to 15;
c) providing an electrical voltage source;
d) contacting of the first sintered body and/or of the cathode with the electrolyte;
e) applying an electrical voltage drawn from the electrical voltage source to the anode and cathode;
f) discharging oxygen gas and/or electrolytes with oxygen dissolved therein from the first porous sintered body;
g) discharging hydrogen gas and/or electrolytes with hydrogen dissolved therein from the electrochemical cell;
h) optionally separating oxygen from the electrolyte discharged by the first porous sintered body;
i) optionally separating hydrogen from the electrolyte discharged from the cell;

The electrolyte used here contains the water to be electrolysed. The pH of the electrolyte is adjusted to the basic region (pH 7 to pH 15) through the addition of an alkaline substance such as NaOH or KOH to the water. The water in the electrolyte is thus broken down in the water electrolysis and therefore supplied continuously to the electrolyte.

The process can be operated in two variants: wet and semi-dry. In the wet variant, both compartments are charged with the electrolyte. In the semi-dry mode of operation, only one of the two compartments is charged with the electrolyte, either on the anode side (situation 1) or on the cathode side (situation 2).

In the wet version, both compartments are soaked with the aqueous basic electrolyte on both sides of the membrane. The hydrogen accumulates in the aqueous electrolyte on the cathode side, the oxygen on the anode side. If the gas does not bubble out of the electrolyte of its own accord, the electrolyte is drawn off from both compartments and freed of the desired gas.

In practice, there may also be mixed forms in which both a portion of the gas formed escapes from the porous sintered body of its own accord and in which another portion remains dissolved in the water and has to be separated therefrom in a separate operation.

Unlike in the wet process variant, in the semi-dry variant it is only either just the anodic side (anode, situation 1) or just the cathodic side (cathode, situation 2) that is soaked with a basic electrolyte. The cathodic or anodic compartment remains dry. From there, the hydrogen gas or hydrogen-enriched basic electrolyte or the oxygen gas or oxygen-enriched basic electrolyte is drawn off from the second porous sintered body (cathode) or from the first porous sintered body (anode). In situation 1, the oxygen accumulates in the anodic compartment filled with the basic electrolyte, as in the case of the wet variant. In situation 2, the hydrogen accumulates in the cathodic compartment filled with the basic electrolyte, as in the case of the wet variant.

What is advantageous in the two semi-dry variants is that there is no need for separation of the basic electrolyte and hydrogen (situation 1) or oxygen (situation 2), since corresponding electrodes are not soaked with the basic electrolyte and hence the gas formed contains very little water. The basic idea of a semi-dry AEM process with water solely on the anodic side (situation 1) is described in WO 2011/004343 A1.

In the semi-dry process (situation 1) there is thus no need for the second porous sintered body to be soaked and for the hydrogen to be separated. The hydrogen formed is directly present in gaseous form in the cathodic compartment.

In practice, in situation 1 there may also be mixed forms in which both a portion of the oxygen escapes from the first porous sintered body of its own accord and in which another portion remains dissolved in the water and has to be separated therefrom in a separate operation. But if hydrogen recovery is the sole aim, it is possible to dispense with the separation of the oxygen from the electrolyte drawn off from the first porous sintered body. The oxygen remains in the electrolyte. This procedure is particularly energy-efficient because there is no need to separate hydrogen and oxygen from the electrolyte.

Separate separation of the oxygen can be dispensed with when the electrolysis is run in such a way that only the cathodic side (cathode, situation 2) is soaked with the basic electrolyte.

In practice, in situation 2 too there may be mixed forms in which both a portion of the hydrogen escapes from the first porous sintered body of its own accord and in which another portion remains dissolved in the electrolyte and has to be separated therefrom in a separate operation.

What is common to all the process variants presented here is that the porous structure of the sintered bodies is utilized to conduct the reactants to the catalytically active centres of the electrocatalyst. The porous sintered bodies in all cases, in accordance with the invention, fulfil the function of a fluid conductor. Depending on the embodiment (wet, semi-dry situation 1, semi-dry situation 2), the fluid conducted in the porous sintered body is liquid electrolytes, liquid electrolyte with hydrogen dissolved therein, liquid electrolyte with oxygen dissolved therein, oxygen gas or hydrogen gas. In addition, the fluid may contain multiple phases composed of the gases and liquids mentioned.

A particular advantage of the structure of the electrochemical cell presented here is that it can be used for different process variants without any need for structural alteration. Consequently, the manufacturer of the electrochemical cell need only produce one design of the cell and the user of the cell can then decide which process variant (wet, semi-dry, etc.) is the most cost-effective for his/her application. The reduction in complexity allows the costs of producing the cell to be greatly lowered.

All the process variants presented here are preferably executed continuously. This means that an aqueous basic electrolyte is supplied continuously and gases or oxygen-and/or hydrogen-enriched electrolyte are drawn off continuously. The continuous supply of the electrolyte compensates for the loss of the water present therein that is due to the electrolysis. Otherwise, the water would be entirely electrolysed over time and the electrolyte lost. The electrochemical reaction would then come to a standstill. Although a batch process in which the electrochemical cell is filled completely, or at least its anodic compartment filled, with electrolyte and this is electrolysed until the cell or the anodic compartment is empty is conceivable, it is not preferred on an industrial scale.

The process of the invention is preferably carried out in an electrolyser comprising at least two electrochemical cells of the invention that share a common bipolar plate. This means that a bipolar plate is in contact with the anode of the first electrochemical cell of the electrolyser and with the cathode of the second electrochemical cell of the electrolyser at the same time. The two adjacent cells are in that case connected in series. Such an electrolyser is also provided by the invention.

The advantage of an electrolyser in which adjacent cells each share a bipolar plate is the compact stack construction thereof and hence the small construction size thereof. Preferably, the electrolyser comprises more than two adjacent cells that share a common bipolar plate. Depending on the size of the individual electrochemical cells and on the output required, it is possible for up to 250 cells to be stacked into one electrolyser via bipolar plates.

A further advantage of the electrolyser of the invention is that it can be manufactured with a high degree of automation: This is because the individual components of the electrochemical cells can be stacked very efficiently with a robot. This allows production costs for the electrolyser to be further reduced.

The invention likewise provides a process for producing an electrolyser comprising at least two electrochemical cells of the invention that share a common bipolar plate when the following components are stacked directly one on top of another in this sequence in the course of production:

In this process sequence of events, stacking is from anode to cathode.
a) a first porous sintered body;
b) an anion-conducting membrane;
c) optionally a catalyst layer;
d) a cathode;
e) a bipolar plate;
f) a first porous sintered body;
g) an anion-conducting membrane;
h) optionally a catalyst layer;
i) a cathode.

It is equally possible to stack from cathode to anode. The stack sequence is then as follows:
a) a cathode;
b) optionally a catalyst layer;
c) an anion-conducting membrane;
d) a first porous sintered body;
e) a bipolar plate;
j) a cathode;
k) optionally a catalyst layer;
l) an anion-conducting membrane;
m) a first porous sintered body;

Both stack sequences result in the same electrolyser. In order to contact more than two adjacent cells of the invention with one another in accordance with the invention via a common bipolar plate, it is possible to run through the stack sequences repeatedly. After each run, a bipolar plate should be inserted.

For example, the stack sequence when three cells are stacked from anode towards cathode is as follows:
a) a first porous sintered body;
b) an anion-conducting membrane;
c) optionally a catalyst layer;
d) a cathode;
e) a bipolar plate;
f) a first porous sintered body;
g) an anion-conducting membrane;
h) optionally a catalyst layer;
i) a cathode;
j) a bipolar plate;
k) a first porous sintered body;
l) an anion-conducting membrane;
m) optionally a catalyst layer;
n) a cathode.

All stacks may be provided at either end of the stack with an end plate that is structured like the bipolar plate, but connected in a monopolar manner.

The stacking is preferably automated, especially using a robot.

The production of the electrolyser is particularly effective when the first and second sintered bodies consist of the same material. It is particularly preferable when the same sintered body is used both as anode and cathode. In this case, the number of different components is smaller, which increases the speed of assembly and reduces electrolyser costs. In that case too, the stacking process is better executable with a robot because the robot does not need to distinguish between anode and cathode, but instead has to install just one kind of sintered body as an electrode. It then does not matter if stacking takes place from cathode to anode or the other way round.

The invention further provides for the intended use of the electrochemical cell in alkaline membrane water electrolysis.

### BRIEF DESCRIPTION OF THE FIGURES

The invention will now be described by working examples. In this regard, the figures show:

FIG. 1a: Schematic diagram of the design of a first embodiment of an electrochemical cell;

FIG. 1b: Schematic diagram of the operation of the first embodiment of an electrochemical cell (FIG. 1a) in a wet process variant;

FIG. 1c: Schematic diagram of the operation of the first embodiment of an electrochemical cell (FIG. 1a) in a semi-dry process variant (situation 1—“dry cathode”);

FIG. 1d: Schematic diagram of the operation of the first embodiment of an electrochemical cell (FIG. 1a) in a semi-dry process variant (situation 2—“dry anode”);

FIG. 2a: Schematic diagram of the design of a second embodiment of an electrochemical cell;

FIG. 2b: Schematic diagram of the operation of the second embodiment of an electrochemical cell (FIG. 2a) in a wet process variant;

FIG. 2c: Schematic diagram of the operation of the second embodiment of an electrochemical cell (FIG. 2a) in a semi-dry process variant (situation 1—“dry cathode”):

FIG. 2d: Schematic diagram of the operation of the second embodiment of an electrochemical cell (FIG. 2a) in a semi-dry process variant (situation 2—“dry anode”);

FIG. 3: Schematic diagram of one operating variant of an electrolyser comprising two electrochemical cells according to the first embodiment (FIG. 1a);

FIG. 4: Schematic diagram of the design of an electrolyser comprising two electrochemical cells according to the second embodiment (FIG. 2a);

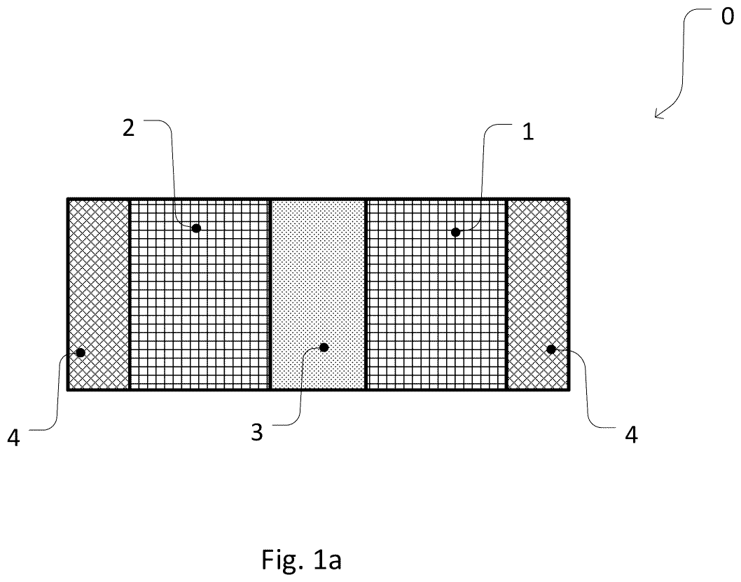

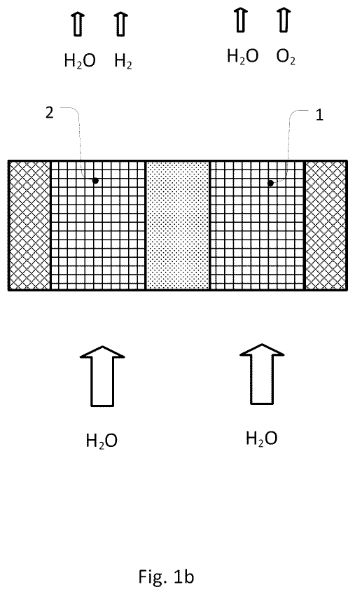

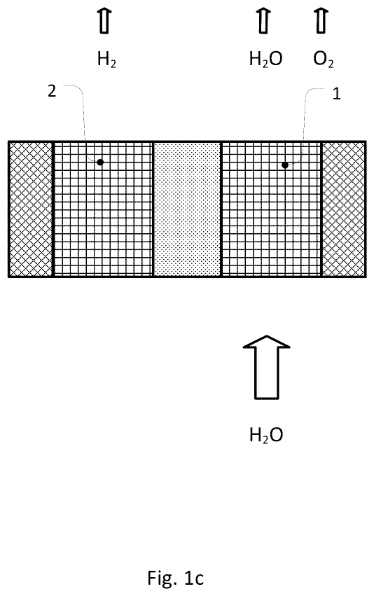

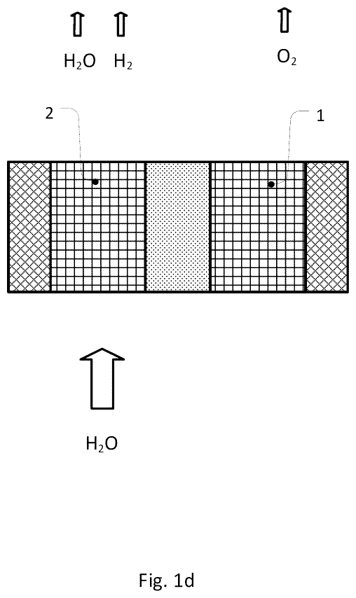

FIG. 1a shows in schematic form a first embodiment of an electrochemical cell 0 in cross section. This comprises an anode 1, a cathode 2, and an anion-conducting membrane 3 arranged between anode 1 and cathode 2. The anode 1 and cathode 2 are each executed as a porous sintered body. The porosity is by way of example 38%. It can be distributed homogeneously within the sintered body or it can follow a gradient such that the porosity increases with increasing distance from the membrane 3.

Membrane 3 is a flat membrane made of an anion-conducting polymer. The membrane 3 separates the electrochemical cell 0 into two compartments: an anodic compartment on the side of the anode 1 and a cathodic compartment on the side of the cathode 2. The anode 1 and cathode 2 each directly adjoin the membrane 3. On their side remote from the membrane 3, the anode 1 and cathode 2 are each in contact with an end plate 4.

The effective area of the anode 1 and cathode 2 extends perpendicularly to the plane of the drawing.

The embodiment of the electrochemical cell 0 shown in FIG. 1a does not have a separate flow distributor or a separate porous transport layer (PTL) or separate catalytically active catalyst layers. The function of PLT is assumed by the anode 1 and the cathode 2 themselves, since they consist of a porous sintered body that is at once fluid-conducting. The flow distributor may however be incorporated into the end plates 4 (not shown). The compartments of the cell thus comprise solely the respective sintered body 1, 2. The sintered material comprises nickel and iron. In the simplest case, the material of which the grains consist is stainless steel, which generally comprises nickel and iron. In the operation of the cell, oxidation of nickel and iron forms a mixed Ni—Fe oxide or mixed Ni—Fe hydroxide that is catalytically active. The sintered material consequently has a catalytic activity; no additional catalyst layer is needed.

The electrochemical cell 0 permits three modes of operation: wet, semi-dry situation 1 and semi-dry situation 2.

FIG. 1b shows schematically the operation of the electrochemical cell from FIG. 1a in a wet process variant. Anode 1 and cathode 2 are here soaked with water or a basic electrolyte and permeated therewith in electrolysis operation.

FIG. 1c shows a semi-dry process variant in which only the anode 1 of the electrochemical cell 0 from FIG. 1a is soaked with water or a basic electrolyte and is permeated therewith in electrolysis operation (semi-dry situation 1). The cathode 2 remains dry.

FIG. 1d shows a semi-dry process variant in which only the cathode 2 of the electrochemical cell 0 from FIG. 1a is soaked with water or a basic electrolyte and is permeated therewith in electrolysis operation (semi-dry situation 2). The anode 1 remains dry.

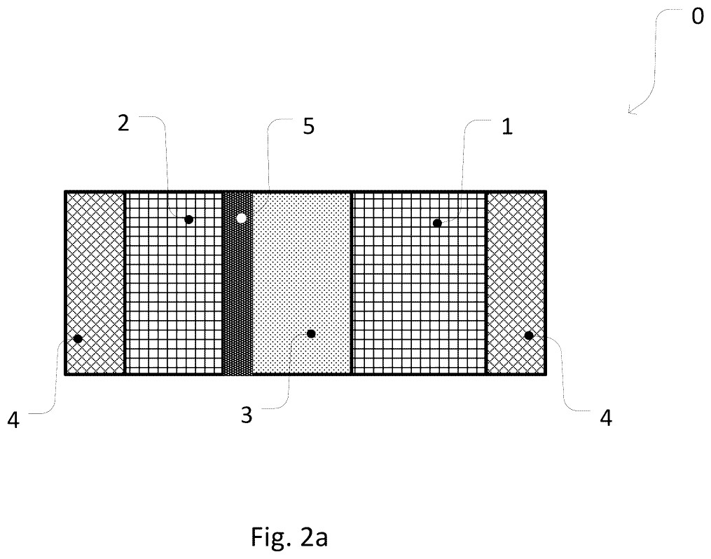

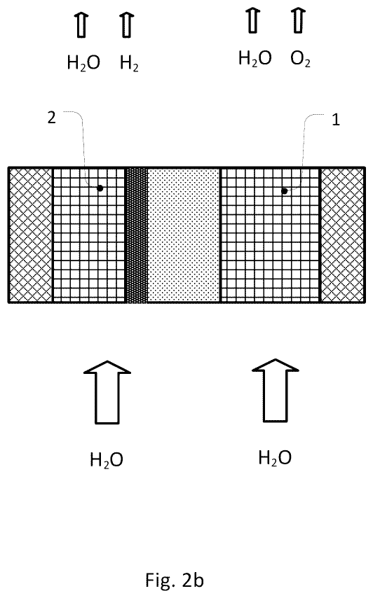

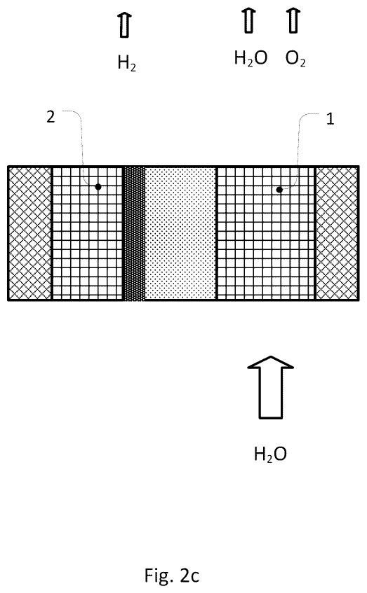

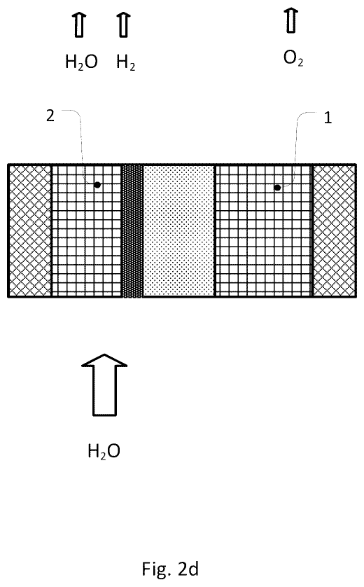

FIG. 2a shows in schematic form the design of a second embodiment of an electrochemical cell 0 in cross section. This comprises an anode 1, a cathode 2, and an anion-conducting membrane 3 arranged between anode 1 and cathode 2. The anode 1 and cathode 2 are each executed as a porous sintered body composed of nickel-containing grains. Membrane 3 is a flat membrane made of an anion-conducting ionomer that divides cell 0 into two compartments. The two electrodes (anode 1 and cathode 2) directly adjoin the membrane 3. On their side remote from the membrane 3, the anode 1 and cathode 2 are each in contact with an end plate 4.

The second embodiment is characterized by a catalyst layer 5 arranged between the cathode 2 and membrane 3. The catalyst layer 5 may here have been applied to the cathode 2 and/or to the cathodic side of the membrane 3. The catalyst layer 5 is thus present in the cathodic compartment. It comprises catalytically active particles (electrocatalyst) that are fixed with an ionomer on the cathode 2 or on the membrane 3. The catalytically active particles are Au-, Pt-, Rh-, Ru-, Pd-, Ag-, Ni-, Co-, Cu-, Fe-, Mn-, Mo-containing metallic particles or alloys or coating or compounds, for example sulfides, selenides, oxides, mixed oxides, hydroxides, mixed hydroxides, spinels or perovskites having a particle size or coating thickness of 1 nm to 10 μm. The catalytically active particles present in the catalyst layer 5 may be unsupported or supported on carbonaceous materials, for example carbon black or charcoal, or on oxides, for example CeO₂, TiO₂ or WO₃. The concentration of the electrocatalyst is between 0.01 mg/cm² and 25 mg/cm², preferably between 0.05 mg/cm² and 5 mg/cm², based on the membrane or electrode area (cathode 2). The thickness of the particle-containing catalyst layer is between 1 μm and 500 μm, preferably between 5 μm and 100 μm. The ionomer is the same material from which the membrane 3 has been produced. When the catalyst layer 5 is applied to the membrane 3, the resulting structure is a “catalyst coated membrane” (CCM). If the catalyst layer 5 is applied to the cathode 2, the resulting structure is a “catalyst coated substrate” (CCS). Based on the schematic representation in FIG. 2a alone, it is not possible to establish whether a CCM or CCS variant is depicted.

The electrochemical cell 0 from FIG. 2a likewise permits three modes of operation: wet, semi-dry situation 1 and semi-dry situation 2.

FIG. 2b shows the wet process variant in which anode 1 and cathode 2 are soaked with water or a basic electrolyte and permeated therewith in electrolysis operation.

FIG. 2c shows the semi-dry process variant in which only the anode 1 is soaked with water or a basic electrolyte and is permeated therewith in electrolysis operation (semi-dry situation 1). The cathode 2 remains dry.

FIG. 2d shows the semi-dry process variant in which only the cathode 2 is soaked with water or a basic electrolyte and is permeated therewith in electrolysis operation (semi-dry situation 2). The anode 1 remains dry.

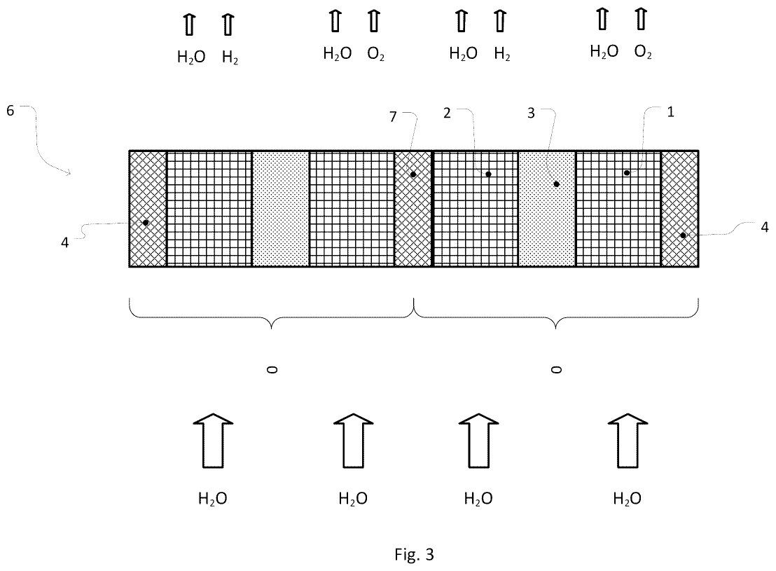

FIG. 3 shows in schematic form a first embodiment of an electrolyser 6 in wet operation. The electrolyser 6 comprises two adjacent electrochemical cells 0 according to the first embodiment that are of identical construction and are in contact via a common bipolar plate 7.

For the performance of water electrolysis with the first electrolyser 6, all electrodes are soaked with water or with a basic electrolyte and permeated continuously therewith in electrolysis operation. This mode of operation corresponds to the process variant described above as “wet”, because all sintered bodies are soaked and permeated with water or with a basic electrolyte. Then an electrical voltage acting between anode 1 and cathode 2 is applied to each cell. The effect of this, according to the principle described above, is water electrolysis and associated release of hydrogen (H₂) in the porous sintered bodies that form the cathode 2 and of oxygen (O₂) in the porous sintered bodies that form the anode 1. Oxygen (O₂), hydrogen (H₂) and unsplit water (H₂O) or basic electrolyte are correspondingly drawn off from the anode 1 and cathode 2, and water or basic electrolyte are pumped continuously through anode 1 and cathode 2.

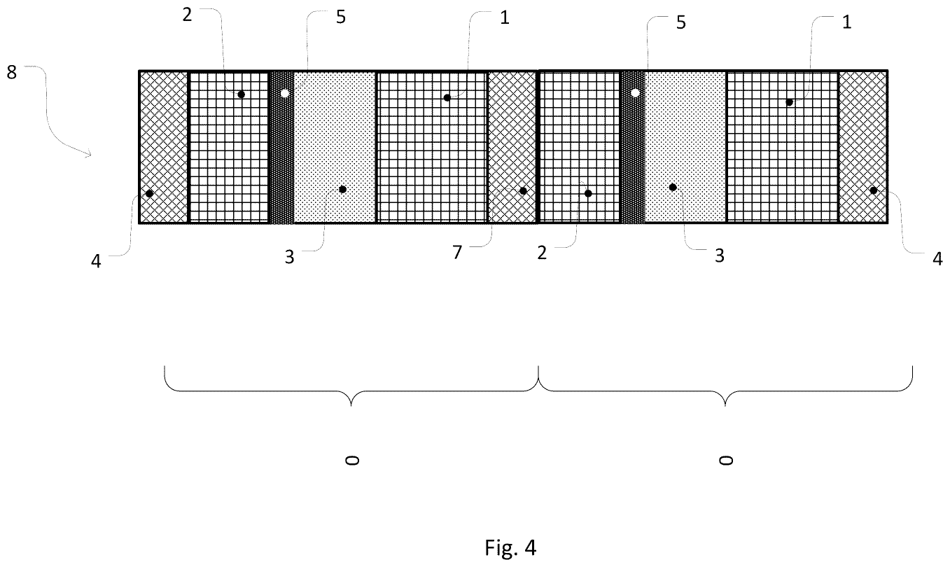

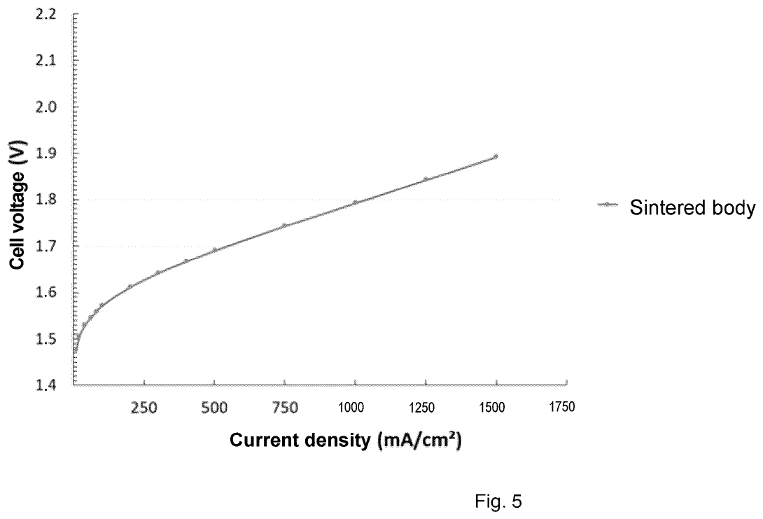

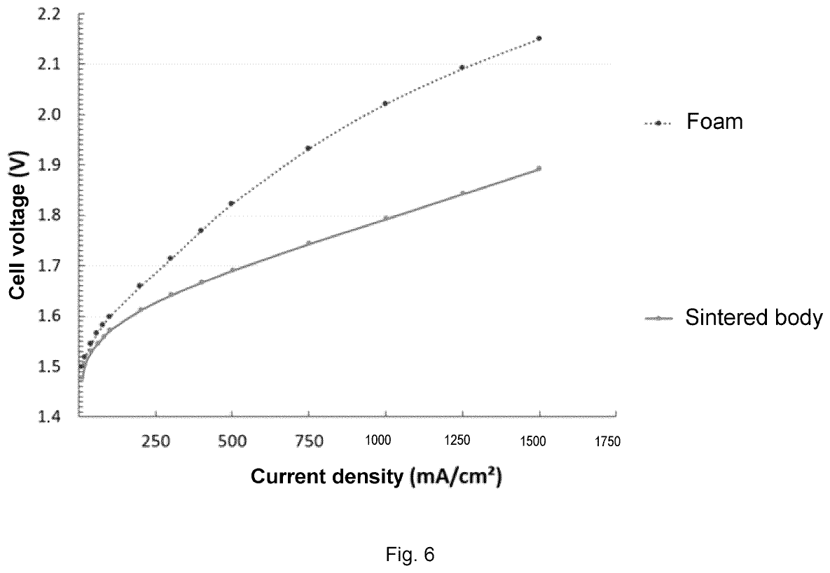

FIG. 4 shows in schematic form a second embodiment of an electrolyser 8 in operation. The second electrolyser 8 comprises two adjacent electrochemical cells 0 according to the second embodiment that are of identical construction and are in contact via a common bipolar plate 7.

For the performance of water electrolysis with the second electrolyser 8, all electrodes are soaked with water or with a basic electrolyte and permeated therewith in electrolysis operation. This mode of operation corresponds to the process variant described above as “wet”, because both sintered bodies are soaked with water or with a basic electrolyte. Then an electrical voltage acting between anode 1 and cathode 2 is applied to each cell. The effect of this, according to the principle described above, is water electrolysis and associated release of hydrogen (H₂) in the porous sintered bodies that form the cathode 2 and of oxygen (O₂) in the porous sintered bodies that form the anode 1. Oxygen (O₂), hydrogen (H₂) and unsplit water (H₂O) or basic electrolyte are correspondingly drawn off from the anode 1 and cathode 2, and water or basic electrolyte are pumped continuously through anode 1 and cathode 2.

### EXPERIMENTS

The effects achieved with the invention will now be demonstrated with reference to experimental data. For this purpose, a porous sintered body is used as anode material in an electrolysis test cell for AEM water electrolysis. As a comparison, a nickel foam was used as anode material.

### 1. Production of an Ionomer (Not Part of the Invention)

An anion-conducting polymer was synthesized in accordance with example 3 of EP3770201 A1.

### 2. Production of an Anion-Conducting Membrane (Not Part of the Invention)

A membrane was then produced from the anion-conducting polymer synthesized in 1, as described in example 4 of EP3770201A1. Each experiment used a fresh piece of membrane that had undergone prior ion exchange in 1 M KOH for 24 hours at 60° C.

### 3. Production of an Active Test Cathode (Not Part of the Invention)

An ink was produced from carbon-supported platinum (60% by weight of Pt on carbon support, article No. AB204745, aber GmbH, Germany). This was done by adding, per part by weight of platinum-based catalyst, first 44 parts of water, then 44 parts of ethanol and lastly 5 parts of ionomer solution (5% of the ionomer produced in 1. in DMSO), then shaking the ink and dispersing by sonication for 30 minutes.

For the production of a cathode, a carbon fibre nonwoven (TGP-H120, thickness=370 μm, porosity=78%, sample designation “carbon fibre nonwoven”, Toray Industries Inc., JP) was selected as the substrate. The substrate was coated with the Pt/C-containing ink, the production of which was described above, using a Prism 400 ultrasonic spray coater (from Ultrasonic Systems, Inc, Haverhill, MA, US). The loading of platinum Pt was 0.6 mg/cm².

### 4. Electrolyte Measurement in Test Cell

A diagram of the electrolyte test cell is shown in FIG. 2a. All the working examples were executed in an electrochemical cell 0 consisting of anode 1, cathode 2, membrane 3, and two end plates 4 with active area of 16 cm². A component of the cathode 3 is the catalyst coating 5 described above. The cathode 3 is thus a catalyst-coated substrate (CCS).

The end plates 4 have flow fields in the form of 1.5 mm wide elongated channels with one inlet and one outlet per channel (this is not shown in FIG. 2a).

The electrolyte used was 1 M KOH, which was pumped through the anode 1 and through the cathode 2 at 50 mL/min. All experiments were carried out at 60° C., with only the electrolyte thermally equilibrated. Individual special features of the respective working examples are stated separately.

### Example 1 (Inventive)

Here, a porous sintered body (steel SAE 316L, thickness=1.57 mm, porosity=38%, sample designation “sintered body”) is used as anode, without further catalyst coating. This sintered body acts simultaneously as porous transport layer and also as active (anode) catalyst material. FIG. 5 shows the current-voltage curve that was recorded with the described electrolysis test cell.
FIG. 5: Current-voltage curve in example 1

It can be seen that the use of the sintered body without additional anode-side catalyst coating is able to achieve current densities of up to 1.5 A/cm² at less than 1.9 V. This implies high efficiency when used industrially.

### Example 2. (Noninventive)

For this purpose, a foam made of nickel (product code: NI00-FA-000152, thickness=1.6 mm, porosity=95%, Goodfellow, UK, sample designation “foam”) was used as anode, without further catalyst coating. This sintered body acts simultaneously as porous transport layer and also as active (anode) catalyst material. In FIG. 6, the current-voltage curve that was recorded with the nickel foam anode is shown as a dotted line. The solid line is the current-voltage curve from FIG. 5 that was recorded with the sintered steel anode.
FIG. 6: Current-voltage curve in example 2 and example 1

It can be seen that, when using the nickel foam (dotted line), significantly higher voltages are reached than when using the sintered body (solid line). A current density of 1.5 A/cm² is for example not reached here until 2.15 V. This relatively high voltage means very low efficiency in usc. Industrially, this would mean that more energy (>10%) would have to be expended for production of the same amount of hydrogen.

### Conclusion

From the comparison of the two examples it is clear that the use of sintered bodies as anode material for AEM water electrolysis represents a significant improvement in efficiency over foamed electrodes.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding European application No. 23173271.0, filed May 15, 2023, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### LIST OF REFERENCE SYMBOLS

0 Electrochemical cell
1 First porous sintered body (anode)
2 Second porous sintered body (cathode)
3 Anion-conducting membrane
4 End plate
5 Catalyst layer
6 Electrolyser comprising two adjacent electrochemical cells 0 in contact via a common bipolar plate 7, according to the first embodiment
7 Bipolar plate
8 Electrolyser comprising two adjacent electrochemical cells 0 in contact via a common bipolar plate 7, according to the second embodiment
H₂O Water or a basic electrolyte
H₂ Hydrogen
O₂ Oxygen

1. An electrochemical cell (0) for alkaline membrane water electrolysis, comprising:
an anode (1), a cathode (2), and an anion-conducting membrane (3) arranged between anode (1) and cathode (2),
characterized in that
the anode (1) is partly or entirely executed as a first porous sintered body (1) comprising grains that are fused together at their grain boundaries, and that the first porous sintered body (1) is in direct contact with the membrane (3).

2. The electrochemical cell (0) of claim 1, wherein the grains of the first porous sintered body (1) comprise a catalytically active material or consist thereof, wherein the catalytically active material comprises at least one transition metal selected from the list consisting of the following transition metals: Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg, Ac, Rf, Db, Sg, Bh, Hs, Mt, Ds, Rg.

3. The electrochemical cell (0) of claim 1, wherein the grains of the first porous sintered body (1) comprise nickel.

4. The electrochemical cell (0) according to claim 3, wherein the grains of the first porous sintered body (1) consist of a material selected from the group consisting of the following materials: nickel, nickel-containing alloys, Hastelloy, Chronin, Monel, Inconel, Incoloy, Invar, Kovar; steel containing nickel, stainless steel containing nickel, and steel of the AISI 301, AISI 301L, AISI 304, AISI 304L, AISI 310, AISI310L, AISI316, AISI 316L, AISI 317, AISI 317L and AISI 321 steel types.

5. The electrochemical cell (0) according to claim 1, wherein no catalyst layer is arranged between the first porous sintered body (1) and the membrane (3).

6. The electrochemical cell (0) according to claim 1, wherein the porosity P of the first porous sintered body (1) is between 5% and 60% or between 15% and 45%, where the porosity P is determined according to the following formula:
$$P = 1 - {ρ}_{V} / {ρ}_{M}$$
where ρ_{V} is the volumetric density of the first porous sintered body (1) and ρ_{M} is the solid density of the grains of the first porous sintered body (1).

7. The electrochemical cell (0) according to claim 6, wherein the porosity P changes along a gradient, where the gradient is disposed perpendicularly to an interface between the first porous sintered body (1) and membrane (3) and where the porosity P decreases in the direction of the membrane (3).

8. The electrochemical cell (0) according to claim 1, wherein the pores of the first porous sintered body (1) are smaller than the grains of the first porous sintered body (1), assessed in sectional view by light microscopy.

9. The electrochemical cell (0) according to claim 1, wherein the cathode (2) is partly or entirely executed as a second porous sintered body (2) comprising grains that are fused together at their grain boundaries.

10. The electrochemical cell (0) according to claim 9, wherein the grains of the second porous sintered body (2) comprise a catalytically active material or consist thereof, wherein the catalytically active material comprises at least one transition metal selected from the list consisting of the following transition metals: Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg, Ac, Rf, Db, Sg, Bh, Hs, Mt, Ds, Rg.

11. The electrochemical cell (0) according to claim 9, wherein the grains of the second porous sintered body (2) comprise nickel.

12. The electrochemical cell (0) according to claim 11, wherein the grains of the second porous sintered body (2) consist of a material selected from the group consisting of the following materials: nickel, nickel-containing alloys, Hastelloy, Chronin, Monel, Inconel, Incoloy, Invar, Kovar; steel containing nickel, stainless steel containing nickel, and steel of the AISI 301, AISI 301L, AISI 304, AISI 304L, AISI 310, AISI310L, AISI316, AISI 316L, AISI 317, AISI 317L and AISI 321 steel types.

13. The electrochemical cell (0) according to claim 1, wherein a catalyst layer (5) is arranged between the cathode (2) and the membrane (3).

14. The electrochemical cell (0) according to claim 13, wherein the catalyst layer (5) comprises at least one element or a compound of an element that is selected from the group consisting of the following elements: Pt, Ru, Pd, C, Ni, Mo, Co, Cu, Fe, Cr.

15. The electrochemical cell (0) according to claim 13, wherein the catalyst layer (5) comprises an anion-conducting polymer.

16. The electrochemical cell (0) according to claim 15, wherein the anion-conducting polymer contains a repeat unit that is also contained in the membrane (3).

17. The electrochemical cell (0) according to claim 1, wherein the first porous sintered body (1) and/or the second porous sintered body (2) is in contact with a bipolar plate (7) on their side remote from the membrane (3).

18. The electrochemical cell (0) according to claim 17 wherein the bipolar plate (7) consists of a material selected from the group consisting of the following materials: nickel; nickel-containing alloys, Hastelloy, Chronin, Monel, Inconel, Incoloy, Invar, Kovar; steel containing nickel, stainless steel containing nickel, steels of the AISI 301. AISI 301L, AISI 304, AISI 304L, AISI 310, AISI310L, AISI316, AISI 316L, AISI 317, AISI 317L and AISI 321 steel types; nickel-plated steel, nickel-plated stainless steel, nickel-plated titanium, nickel-plated brass, nickel-plated aluminium, nickel-plated acrylonitrile-butadiene-styrene copolymer, and carbon.

19. A process for producing hydrogen (H₂) and oxygen (O₂) by electrochemical splitting of water (H₂O), having the following steps:
a) providing at least one electrochemical cell (0) according to claim 1;
b) providing an aqueous electrolyte having a pH of 7 to 15;
c) providing an electrical voltage source;
d) contacting of the first sintered body (1) and/or of the cathode (2) with the electrolyte;
e) applying an electrical voltage drawn from the electrical voltage source to the anode (1) and cathode (2);
f) discharging oxygen gas (O₂) and/or electrolytes with oxygen (O₂) dissolved therein from the first porous sintered body (1);
g) discharging hydrogen gas (H₂) and/or electrolytes with hydrogen (H₂) dissolved therein from the electrochemical cell (0);
h) optionally separating oxygen (O₂) from the electrolyte discharged by the first porous sintered body (1);
i) optionally separating hydrogen (H₂) from the electrolyte discharged from the cell (0);

20. The process according to claim 19,
wherein the process is performed by an Electrolyser (6, 8) comprising at least two electrochemical cells (0) comprising an anode (1), a cathode (2), and an anion-conducting membrane (3) arranged between anode (1) and cathode (2),
characterized in that
the anode (1) is partly or entirely executed as a first porous sintered body (1) comprising grains that are fused together at their grain boundaries, and that the first porous sintered body (1) is in direct contact with the membrane (3),
wherein the first porous sintered body (1) and/or the second porous sintered body (2) is in contact with a bipolar plate (7) on their side remote from the membrane (3) and
wherein the at least two electrochemical cells (0) share a common bipolar plate (7).

21. A process for producing an electrolyser (6, 8) according to claim 20, wherein the following components are stacked directly one on top of another in this sequence:
a) a first porous sintered body (1);
b) an anion-conducting membrane (3);
c) optionally a catalyst layer (5);
d) a cathode (2);
e) a bipolar plate (7);
f) a first porous sintered body (1);
g) an anion-conducting membrane (3);
h) optionally a catalyst layer (5);
i) a cathode (2).

22. The process for producing an electrolyser (6, 8) according to claim 20, wherein the following components are stacked directly one on top of another in this sequence:
a) a cathode (2);
b) optionally a catalyst layer (5);
c) an anion-conducting membrane (3);
d) a first porous sintered body (1);
e) a bipolar plate (7);
f) a cathode (2);
g) optionally a catalyst layer (5);
h) an anion-conducting membrane (3);
j) a first porous sintered body (1).

23. A method comprising performing alkaline membrane water electrolysis with the electrochemical cell (0) of claim 1.
